(19) United States
(12) Patent Application Publication
(10) Pub. No.: US 2024/0263717 A1
(43) Pub. Date: Aug. 8, 2024

(54) CLOSING MECHANISM OF SHUT-OFF VALVE

(71) Applicant: Georg Fischer Rohrleitungssysteme AG, Schaffhauden (CH)

(72) Inventors: Christoph KRAUTER, Gottmadingen (DE); Martin ANDRY, Ftan (CH); Joerg HUNNEKUHL, Jestetten (DE); Jonas HUESSY, Neunkirch (CH); Oliver TREFZ, Bonndorf (DE)

(21) Appl. No.: 18/429,769

(22) Filed: Feb. 1, 2024

(30) Foreign Application Priority Data
Feb. 3, 2023 (EP) 23154812.4

(51) Int. Cl. F16K 31/126; F16K 31/50

(52) U.S. Cl. CPC F16K 31/1262; F16K 31/508

(57) ABSTRACT

A valve unit of a shut-off valve having an actuator stem extending vertically with respect to the throughflow direction for activating a shut-off device, a shut-off device, wherein the shut-off device is adjustably arranged on the actuator stem by means of a threaded connection, a spring element for applying the required closing force to the shut-off device and a control element, axially secured on the actuator stem, for pre-tensioning the spring element, wherein the valve unit has a support nut arranged on the actuator stem and a delimiting element forming a stop for the support nut in order to define the closed position of the shut-off device, wherein the valve unit has two threaded connections arranged on the actuator stem, a threaded connection between the shut-off device and the actuator stem and a threaded connection between the actuator stem and the support nut.

### CROSS-REFERENCE TO RELATED APPLICATIONS

This application claims the benefit and priority of European Patent Application No. 23 154 812.4 filed Feb. 3, 2023. The entire disclosure of the above application is incorporated herein by reference.

### BACKGROUND OF THE INVENTION

### Technical Field

The invention relates to a valve unit of a shut-off valve, preferably of a gate valve or diaphragm valve, comprising an actuator stem extending vertically with respect to the throughflow direction for activating a shut-off device, a shut-off device, wherein the shut-off device is adjustably arranged on the actuator stem by means of a threaded connection, a spring element for applying the required closing force to the shut-off device and a control element, axially secured on the actuator stem, for pre-tensioning the spring element, and to the method.

Such shut-off valves are usually used in supply lines which serve to transport fluid or gaseous media. The valve unit of such a shut-off valve, preferably of a gate valve or diaphragm valve, is aligned perpendicularly to the pipeline or to the centre axis thereof and can also be displaced perpendicularly thereto in order to open or close the shut-off valve. The valve unit has an actuator stem for displacing or activating the shut-off device so that it moves from the open position into the closed position, or vice versa. To activate the valve unit, a torque is applied accordingly to the actuator stem in order to activate the shut-off device. Depending on the corrosion and contamination which occur on the valve, a correspondingly high torque may need to be applied and may consequently result in mechanical damage.

GB 1248958 discloses a shut-off valve which features a quick-closing mechanism. Under normal use, the wedge gate is brought into the closed position by rotating the handwheel and activating the threaded connection between the wedge gate and the stem. High torques may need to be applied here if the threaded connection has jammed. Moreover, the valve has a spring, which acts on the wedge gate and which presses the wedge gate into the closed position for activation in cases of emergency.

### SUMMARY

An aspect of the invention is to propose an apparatus and a method associated therewith, such that the closing force acting on the shut-off device in the closed position of the shut-off valve is uncoupled from the torque required for activation or such that friction forces or torque forces no longer act on the valve unit in the closed position.

This aspect is achieved according to the invention in that the valve unit has a support nut arranged on the actuator stem and a delimiting element forming a stop for the support nut in order to define the closed position of the shut-off device, wherein the valve unit has two threaded connections arranged on the actuator stem, a threaded connection between the shut-off device and the actuator stem and a threaded connection between the actuator stem and the support nut.

The valve unit according to the invention for a shut-off valve preferably comprises a gate valve or diaphragm valve, an actuator stem extending vertically with respect to the throughflow direction for activating a shut-off device. The actuator stem is preferably mounted in a valve housing, wherein the valve housing is preferably made of plastic. The valve unit likewise comprises a shut-off device, wherein the shut-off device is adjustably arranged on the actuator stem by means of a threaded connection. The shut-off device is preferably arranged in a vertically adjustable manner at the bottom end of the actuator stem. The shut-off device is designed preferably as a shut-off wedge in a gate valve and preferably as a diaphragm in a diaphragm valve.

The valve unit comprises a spring element for applying the required closing force to the shut-off device and a control element, axially secured on the actuator stem, for setting or applying the pre-tension of the spring element. The spring element is preferably designed as a pressure spring and is preferably arranged, pre-tensioned, between the delimiting element and the control element, wherein an alternative seating may also be used instead of the delimiting element to define the length of the spring element and therefore the spring force.

The valve unit has a support nut arranged on the actuator stem and a delimiting element, forming a stop for the support nut, to define the closed position—which corresponds to the end position of the shut-off device. The valve unit has two threaded connections arranged on the actuator stem, a threaded connection between the shut-off device and the actuator stem and a threaded connection between the actuator stem and the support nut.

If the valve unit is activated by applying a torque in order to close the valve, the support nut is displaced downwards as a result of the actuator stem rotating in the longitudinally guided and non-co-rotating support nut. The same similarly and simultaneously applies for the shut-off device, which is likewise displaced downwards in a vertically guided manner. The actuator stem rotates in the guided shut-off device and, as a result of the threaded connection and the non-co-rotating shut-off device, the shut-off device is displaced into the closed position. The shut-off device reaches the closed position shortly before the support nut comes to a stop against the delimiting element or abuts against this latter. Since the support nut is not yet positioned against the delimiting element, the torque may still be applied to the actuator stem, which torque acts on the shut-off device. Since the shut-off device has already reached the end position or closed position but a torque is still being applied, the actuator stem rotates slightly further whereas the shut-off device is stationary and is no longer displaced. Therefore, the actuator stem alone is again displaced slightly back upwards or unscrewed somewhat further via the thread. This over-rotation is preferably in the order of magnitude of ¼ to one turn. Accordingly, the spring element may act on the control element, which is secured axially on the actuator stem, or on the actuator stem. As a result of the slight upward displacement of the actuator stem, the control element is lifted off its seat on the housing. The spring element presses on the actuator stem via the control element and applies the closing force to the shut-off device via the actuator stem. As a result, the force of the spring element alone acts on the actuator stem, since the torque is absorbed by the support nut which has come to a stop and the shut-off device is pressed into the closed position by the spring element alone. The control element is preferably seated on the housing until the shut-off device is closed, as a result of which the spring element still has no effect on the shut-off device. Only during the closing movement and the slight over-rotation of the actuator stem, as described above, is the control disc lifted off its seat on the housing, thereby triggering the force effect of the spring element on the actuator stem.

It has proven advantageous if the delimiting element is formed by a seating which is arranged in a bearing bush arranged in the housing. An alternative option is to arrange the delimiting element directly in the housing.

A preferred embodiment consists in the vertically extending actuator stem being of non-rising design. As a result, the valve is not altered externally or the actuator stem projecting out of the housing for coupling to a drive is always at the same height.

It is advantageous if the threaded connection between the shut-off device and the actuator stem and the threaded connection between the actuator stem and the support nut have different pitches. This enables a compact design, since the pitch of the threaded connection at the support nut may be smaller than that for the shut-off device. It has proven advantageous if the pitches of the threaded connection are designed in a ratio to one another of 1:2 to 1:6. This means that it is advantageous if the pitch of the threaded connection at the shut-off device is 2 to 6 times greater than the pitch for the support nut. It has proven particularly preferable if the ratio of the pitches is 1:4.

A preferred embodiment has proven to be one in which the actuator stem consists of multiple parts. As a result of the division into multiple actuator stem sections, the axial displacement of the bottom actuator stem section, which has the external thread of the threaded connection between the shut-off device and the actuator stem, is accommodated by the actuator stem section arranged above it.

It has proven advantageous if the actuator stem comprises at least two actuator stem sections. This enables a division for the top and bottom region and divides the actuator stem preferably after the delimiting element or before the spring element. The actuator stem sections or the ends of the actuator stem sections are preferably displaceably connected to one another in an interlocking manner.

A preferred embodiment has proven to be one in which the actuator stem sections are arranged so as to be axially displaceable with respect to one another. It is advantageous if the top actuator stem section, which is in engagement with the thread of the support nut, is secured axially in the housing and the bottom actuator stem section, which is in engagement with the thread of the shut-off device, is arranged so as to be axially displaceable and the displacement is accommodated by the top actuator stem section. It is advantageous if, to this end, the top actuator stem section has, at the bottom end, an opening in which the top end of the bottom actuator stem section is accommodated with form fit in order to transmit the applied torque for closing or opening the shut-off device to the bottom section or the shut-off device.

According to a preferred embodiment, the actuator stem section which is connected to the shut-off device by means of a threaded connection is arranged in the housing so as to be axially displaceable.

It has proven advantageous if the actuator stem sections are connected to one another with form fit. This enables the torque to be transmitted to the shut-off device.

This aspect is also achieved according to the preferred embodiment of the invention in that the method for closing a shut-off valve includes:
tightening the actuator stem by applying and transmitting a torque to the shut-off device until the closed position of the shut-off device is reached,
continuing the rotation slightly beyond the closed position until the support nut comes to a stop, preferably against the delimiting element, whereby the actuator stem rotates slightly further out of the shut-off device and is displaced axially upwards,
the shut-off device is relieved of torque as a result of the support nut which has come to a stop, whilst the spring force of the spring element alone acts on the shut-off device in order to apply the required closing force.

All possible configurations can be combined freely with one another and, to avoid repetition, the features of the apparatus also relate automatically to the method, and vice versa.

### BRIEF DESCRIPTION OF THE DRAWINGS

An exemplary embodiment of the invention is described with the aid of the figures, wherein the invention is not restricted merely to the exemplary embodiment. In the drawings:

FIG. 1 shows a sectional view through a shut-off valve in an open state,

FIG. 2 shows a sectional view through a shut-off valve in a closed state,

FIG. 3 shows an enlarged partial section in the bearing region in the closed state, and

FIG. 4 shows an enlarged partial section in the bearing region in in the open state.

### DESCRIPTION OF THE PREFERRED EMBODIMENTS OF THE INVENTION

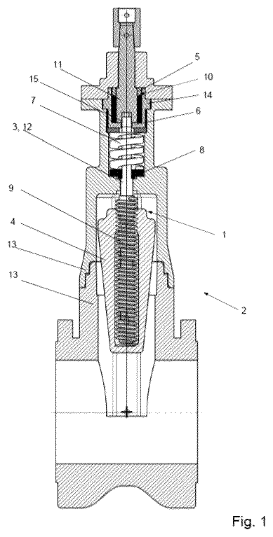

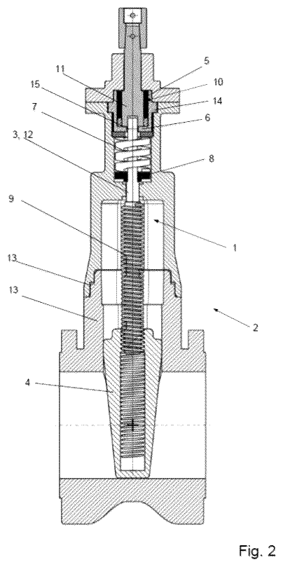

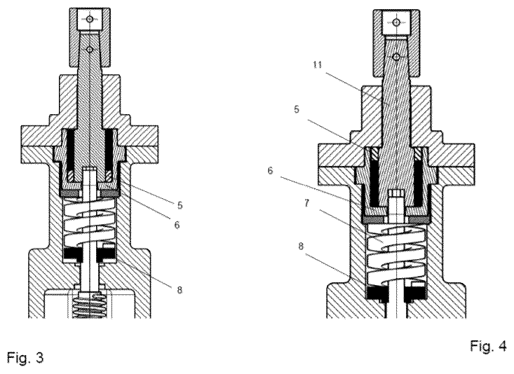

The drawing illustrated in FIG. 1 shows a valve unit 1 according to the invention in a shut-off valve 2. Although the shut-off valve 2 is illustrated solely as a gate valve in the figures, the valve unit 1 according to the invention may equally be used in a diaphragm valve. The valve unit 1 arranged in a valve housing 13 has an actuator stem 3 extending vertically with respect to the throughflow direction. The actuator stem 3 is preferably of non-rising design. A shut-off device 4 is arranged at the bottom end of the actuator stem 3, wherein the shut-off device 4 is preferably designed as a wedge gate in the case of a gate valve (as illustrated) and as a diaphragm in the case of a diaphragm valve. The shut-off device 4 is arranged on the actuator stem 3 in a vertically adjustable or displaceable manner by means of a threaded connection 9 and can thus be displaced upwards for opening and downwards for closing as a result of the actuator stem 3 rotating. The shut-off device 4 has an internal thread, which is in engagement with the external thread on the actuator stem 3. Moreover, the valve unit 1 has a spring element 7, which applies the closing force to the shut-off device 4 in the closed state of the valve unit 1 or the shut-off valve 2. The spring element 7 acts on the control element 8, which is arranged, axially secured, on the actuator stem 3. A support nut 5 is arranged in the top region of the valve unit 1 and, in cooperation with the delimiting element 6, serves to delimit the movement path of the valve unit 1 or the shut-off device 4. As a result of the threaded connection 10 between the support nut 5 and the actuator stem 3, the support nut 5, which is linearly guided by the housing 13 or by a bearing bush 14 arranged in the housing, is moved downwards, or displaced in the direction of the delimiting element 6, as a result of the rotating actuator stem 3 when a torque is applied. At the same time, the shut-off device 4 also moves downwards due to the rotating actuator stem 3. The shut-off device 4 reaches the closed position in the valve housing 13 shortly before the support nut 5 is positioned against the delimiting element or comes to a stop. A slight further travel of the actuator stem 4 can then be realized, preferably in the order of magnitude of a quarter turn to a full turn. The support nut 5 then comes to a stop, as is clearly shown in FIGS. 2 and 3.

The valve unit 1 according to the invention has two threaded connections 9, 10, with which the support nut 5 and the shut-off device 4 are each displaced longitudinally or vertically during activation for the purpose of closing the valve 2 in the downward direction and opening the valve 2 in the upward direction. In the figures, the delimiting element 6 is illustrated as a stop surface in a bearing bush 14 arranged in the housing 13. It goes without saying that the delimiting element 6 may also be incorporated directly in the housing 13 or, in a different embodiment, arranged fixed in the housing 13. In the illustrated figures, the spring element 7 is arranged between the control element 8 and a further disc below the delimiting element 6. It goes without saying that this disc may also be omitted, and the spring element 7 may also be supported on another fixed seating instead of the delimiting element in order to achieve pre-tension. In the open position in FIGS. 1 and 4, it can be seen that the control element 8 is still positioned against the housing 13 such that it is delimited at the bottom and the spring element 7 still has no influence on the actuator stem 3 or the shut-off device 4. In the closed position in FIGS. 2 and 3, it can be seen that the control element 8 is no longer seated on the housing 13 and, as a result of the control element 8 being axially secured on the actuator stem 3, the spring element 7 acts on the control element 8 and, in turn, on the actuator stem 3 and the shut-off device 4. Moreover, it can be seen in FIG. 2 that the support nut 5 has come to a stop and abuts against the delimiting element 6. It has proven advantageous if the actuator stem 3 consists of multiple parts (as shown in the figures). A two-part embodiment is shown, wherein the two actuator stem sections 11, 12 are arranged so as to be displaceable with respect to one another. The top actuator stem section 11 is mounted in the housing 13 in an axially secured manner. The bottom actuator stem section 12 is mounted so as to be axially displaceable so that the previously described uncoupling of the torque and effect of the spring force may be realized and the actuator stem 3 is preferably not designed as an external rising actuator stem. The actuator stem sections 11, 12 are connected to one another with form fit in the region of the actuator stem section connection 15 in order to transmit the torque. The actuator stem sections 11, 12 are arranged so as to be axially displaceable with respect to one another. In the embodiment shown, this is achieved via an opening at the bottom end of the top actuator stem section 11, into which the top end of the bottom actuator stem section 12 projects. It goes without saying that the inverse of this is also conceivable or other solutions which permit a form-fitting, but still axially displaceable, connection are also possible. Alternatively, this may also be realized by a coupling piece between the actuator stem sections.

What is claimed is:

1. A valve unit of a shut-off valve, preferably of a gate valve or diaphragm valve, comprising an actuator stem extending vertically with respect to the throughflow direction for activating a shut-off device, a shut-off device, wherein the shut-off device is adjustably arranged on the actuator stem by means of a threaded connection, a spring element for applying the required closing force to the shut-off device and a control element, axially secured on the actuator stem, for pre-tensioning the spring element, the valve unit has a support nut arranged on the actuator stem and a delimiting element forming a stop for the support nut in order to define the closed position of the shut-off device, wherein the valve unit has two threaded connections arranged on the actuator stem, a threaded connection between the shut-off device and the actuator stem and a threaded connection between the actuator stem and the support nut.

2. A valve unit according to claim 1, wherein the vertically extending actuator stem is of non-rising design.

3. A valve unit according to claim 1, wherein the threaded connection between the shut-off device and the actuator stem and the threaded connection between the actuator stem and the support nut have different pitches.

4. A valve unit according to claim 1, wherein the actuator stem consists of multiple parts.

5. A valve unit according to claim 1, wherein the actuator stem comprises at least two actuator stem sections.

6. A valve unit according to claim 1, wherein the actuator stem sections are connected to one another with form fit for transmitting a torque.

7. A valve unit according to claim 1, wherein the actuator stem sections are arranged so as to be axially displaceable with respect to one another.

8. A valve unit according to claim 1, wherein the pitches of the threaded connection are designed in a ratio to one another of 1:2 to 1:6.

9. A valve unit according to claim 1, wherein the top actuator stem section is arranged, axially secured, in the housing.

10. A valve unit according to claim 1, wherein the bottom actuator stem section is arranged in the housing so as to be axially displaceable.

11. A method for closing a shut-off valve, comprising:
tightening the actuator stem by applying and transmitting a torque to the shut-off device until the closed position of the shut-off device is reached,
continuing the rotation slightly beyond the closed position until the support nut comes to a stop, whereby the actuator stem rotates slightly further out of the shut-off device and is displaced axially upwards,
the shut-off device is relieved of torque as a result of the support nut which has come to a stop, whilst the spring force of the spring element alone acts on the shut-off device in order to apply the required closing force.
